(19) United States
(12) Patent Application Publication
(10) Pub. No.: US 2002/0066446 A1
(43) Pub. Date: Jun. 6, 2002

(54) Archery bow stand and archery bow with such stand

(76) Inventor: Kalevi Kesti, Huskvarns (SE)

Correspondence Address: Robert G. Lev, 4766 Michigan Boulevard, Youngstown, OH, 44505, US

(21) Appl. No.: 10/045,242

(22) Filed: Nov. 9, 2001

Related U.S. Application Data
(63) Continuation of application No. PCT/SE00/00869, filed on May 4, 2000.

(30) Foreign Application Priority Data
May 11, 1999 (SE) 99001703.0

(51) Int. Cl. F41B 5/00; A45F 3/44; F16M 11/00

(52) U.S. Cl. 124/86; 248/156; 248/176.1

(57) ABSTRACT

A stand for an archery bow, preferably for competition comprising two bow arms (1) at their inner ends joined by a stock with a handle (2), at their outer ends (3), joined by at least one bow string (4,5) is described. A longitudinal stabilizer (6) with a relatively small cross section is fastened to the stock or handle, pointing out from the same. The stand is especially characterized in that the stand (8) comprises a joint means (9), fastened to the stabilizer. It holds with elastic load a longitudinal support element (10) in an optional first or second position. The support element is in the first position substantially parallel to the stabilizer (6) and forms in the second position such an angle or to the same, that one bow arm (1), the stabilizer (6) and the support element (10) form a structure with three support points at a substratum.

The present invention relates to a stand for an archery bow preferably for competition, comprising two bow arms, at their inner ends joined by a stock with a handle, at their outer ends joined by at least one bow string, whereas a longitudinal stabilizer with a relatively small cross section is fastened to the stock or handle, pointing out from same, lying substantially in the same plane as the bow arm. The invention also relates to an archery bow with such a stand.

Archery bows nowadays primarily axe used within sports, that is to say for competition use. There is a need for a simple device intended to support the archery bow when this is not used, but shall be ready for use. Until now there is no such device. According to the invention a stand of the art mentioned introductorily is primarily characterized in that the stand comprises a joint means, fastened to the stabilizer, with elastic load holding a longitudinal support element in an optional first or second position, whereas the support element in the first position is substantially parallel to the stabilizer and in the second position forms such an angle a to the same, that one bow arm, the stabilizer and the support element form a structure with three support points at a substratum. In one preferred embodiment the joint means comprises a housing. in which is provided, in a first direction, a torsional axis for the support element, the housing being designed such, that the support element with an elastic load, preferably caused by a screw spring, in said first direction, may be turned in a plane substantially perpendicular to said first direction, between two positions, in which it may be releasably fastened. optionally in two corresponding: depressions in the housing. The angle between said positions is suitably 70 degrees.

The invention will be described more in detail in the following, reference being made to the enclosed figures, of which:

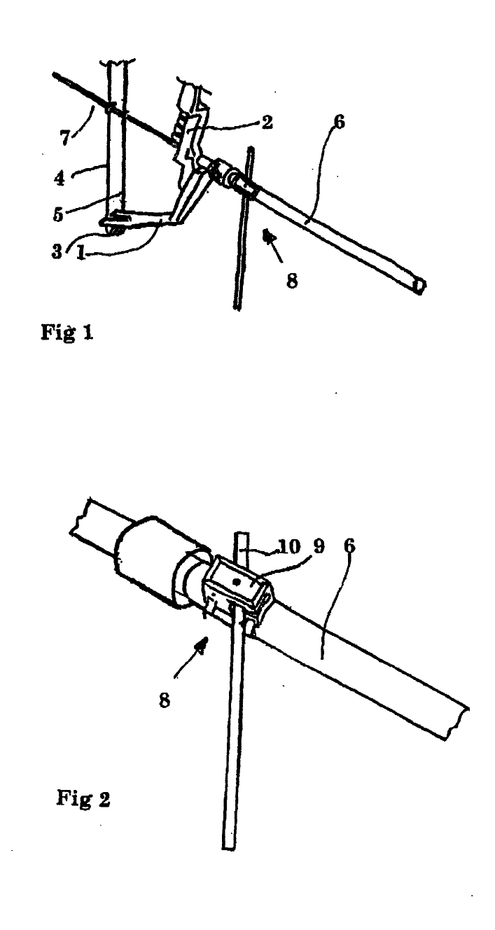

FIG. 1 shows. schematically, the lower portion of an archery bow for competition use, provided with a stand according to the invention,

FIG. 2 shows a detail in larger scale, of the object of FIG. 1,

FIG. 3 shows a housing for a joint means, seen in perspective from above, inclined, and

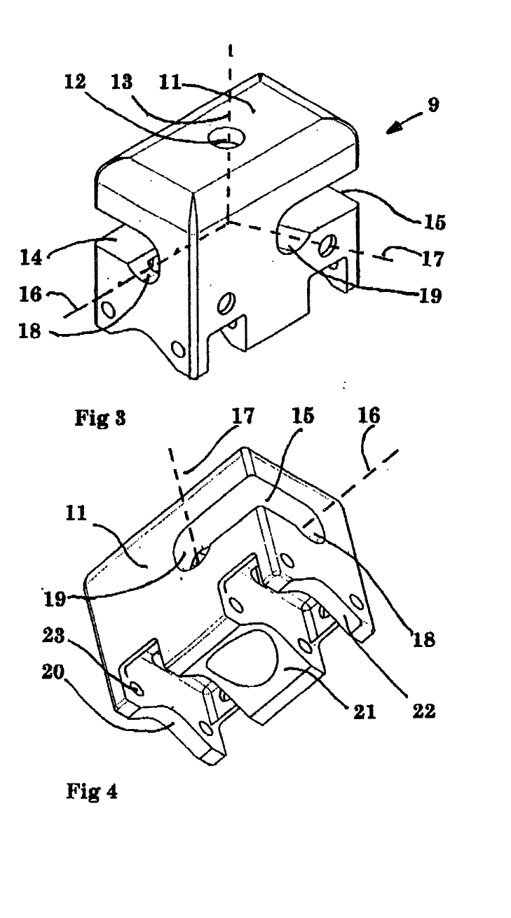

FIG. 4 shows the same housing. seen in perspective from below, inclined.

In FIG. 1 a lower bow arm is denoted by 1, a stock with a handle by 2, the lower end of the bow arm by 3, two bow strings by 4.5, a stabilizer by 6. a guide for the bow strings by 7 and a stand generally by 8. A joint means 9 is, as is seen more clearly from FIG. 2 fastened to the stabilizer near its fastening point to the stock 2.

A supporting element 10 is shown in a position. turned out from the stabilizer. The lower end 8 of the bow arm, the free end of the stabilizer 6 and the lower end of the support element 10 form three support points at a substratum, such that the archery bow may be put ready for use.

The design of the joint means is seen more clearly from FIGS. 3 and 4. In, a housing 11 there is provided an opening 12 with a first symmetry axis 13. In the housing there are first and second recesses 14 and 15 through which there runs a second symmetry axis 16 and a third symmetry axis 17, respectively. The first recess 14 is provided with a depression 18 and the second recess 15 with a depression 19. Both depressions run along its symmetry axis, respectively. The support element 10, which is not shown in the figures, can now take one of two positions, along the two symmetry axes 16 and 17, resting in one of the depressions 18 and 19, in both cases under load by one not shown screw spring, acting in the direction of the first symmetry axis 13. The housing 11 is formed, at its lower side, with arch-formed recesses 20,21 and 22 adapted to stabilizers of different dimensions. Openings, of which one is marked by 23, are provided for bolts, which serve as fastenings for bands, by which the housing 11 is fastened at the stabilizer.

1. A stand for an archery bow, preferably for competition, comprising two bow arms, (1) at their inner ends joined by a stock with a handle (2), at their outer ends (3) joined by at least one bow string (4,5), whereas a longitudinal stabilizer (6) with a relatively small cross section is fastened to the stock or handle, pointing out from same, lying substantially in the Same plane as the bow arms,
characterized in
that the stand (8) comprises a joint means (9), fastened to the stabilizer, with elastic load holding a longitudinal support element (10) in an optional first or second position, whereas the support element in the first position is substantially parallel to the stabilizer (6) and in the second position forms an angle α to the same, that one bow arm (1), the stabilizer (6) and the support element (10) form a structure with three support points at a substratum.

2. A stand according to claim 1,
characterized in
that the joint means comprises a housing (11), in which is provided, in a first direction, a torsional axis (13) for the support element. the housing being designed such that the support element with an elastic load, preferably caused by a screw spring, in said first direction, may be turned in a plane substantially perpendicular to said first direction, between two positions (16.17), in which it may be releasably fastened, optionally in two corresponding depressions (18,19) in the housing.

3. A stand according to claim 2,
characterized in
that the angle a between aid two positions is about 70 degrees.

4. An archery bow for competition use, preferably fur competition use, comprising two bow arms, (I) at their inner ends joined by a stock with a handle (2), at their outer ends (3) joined by at least one how string (4,5), whereas a longitudinal stabilizer (6) with a relatively small cross section is fastened to the Stock or handle, pointing out from same, lying substantially in the same plane as the bow arms,
characterized in
that a joint means (9) is fastened to the stabilizer, with elastic load holding a longitudinal support element (10) in an optional first or second position (16,17), whereas the support element in the first position is substantially parallel to the stabilizer (6) and in the second Position forms such an angle a to the same, that one bow arm (1). the stabilizer (6) and the support element (10) form a structure with three support points at a substratum.

5. An archery bow according to claim 4.
characterized in
that the angle a between said two positions is about 70 degrees.
